(19) United States
(12) Patent Application Publication
(10) Pub. No.: US 2023/0086807 A1
(43) Pub. Date: Mar. 23, 2023

(54) SEGMENTED DIFFERENTIABLE OPTIMIZATION WITH MULTIPLE GENERATORS

(71) Applicants: Adobe Inc., San Jose, CA (US); Czech Technical University in Prague, Prague 6-Dejvice (CZ)

(72) Inventors: Michal LUKÁC, Boulder Creek, CA (US); Elya SHECHTMAN, Seattle, WA (US); Daniel SÝKORA, Praha (CZ); David FUTSCHIK, Liberec (CZ)

(21) Appl. No.: 17/723,879

(22) Filed: Apr. 19, 2022

Related U.S. Application Data
(60) Provisional application No. 63/245,628, filed on Sep. 17, 2021.
(60) Provisional application No. 63/248,268, filed on Sep. 24, 2021.

(51) Int. Cl. G06T 11/60; G06T 7/11

(52) U.S. Cl. CPC G06T 11/60; G06T 7/11; G06T 2207/20104; G06T 2207/20081; G06T 2207/20084

(57) ABSTRACT

Embodiments are disclosed for segmented image generation. The method may include receiving an input image and a segmentation mask, projecting, using a differentiable machine learning pipeline, a plurality of segments of the input image into a plurality of latent spaces associated with a plurality of generators to obtain a plurality of projected segments, and compositing the plurality of projected segments into an output image.

### CROSS-REFERENCE TO RELATED APPLICATIONS

This application claims the benefit of U.S. Provisional Application No. 63/245,628, filed Sep. 17, 2021, and U.S. Provisional Application No. 63/248,268, filed Sep. 24, 2021, which are hereby incorporated by reference.

### BACKGROUND

With the increasing ability of GANs to generate images hardly distinguishable from real photographs, there have been numerous attempts to estimate latent code of the network generating images that look very close to the given input photo. By manipulating those codes in a specific direction, one may alter the appearance of the input photo in a specific way while retaining the original visual features, e.g., adding more hair to a bald person while retaining the person's identity.

This has led to attempts to find an intuitive projection of latent codes into to a space in which important visual features will be disentangled so that the user can perform edits locally. When the visual features are disentangled, this allows for modifications to be made to one visual feature without affecting the other visual features. Unfortunately, there is usually a tradeoff between the ability to get accurate reconstruction while at the same time provide an excellent disentanglement.

Previous techniques assume that the entire image is represented by a single latent code. However, considering all pixels in the input image imposes a large number of constraints, which can make the code estimation difficult. This results in less realistic results and/or features that are not adequately disentangled, making editing of the images more difficult.

### SUMMARY

Introduced here are techniques/technologies that relate to segmented image generation. An image generation system includes one or more generator networks that are trained to generate realistic images. In some embodiments, the input image is segmented using a segmentation mask into multiple regions. Each region may be generated separately using a different generator. As no one generator is responsible for generating the entire image, the projection results in a more accurate image that represents that portion of the input image. Once the projections have been performed, then individual segments of the image can be edited by exploring the latent spaces. This provides more accurate results while also eliminating the risk of an edit made to one portion of the image changing a different portion of the image.

Once the segments have been generated, an output image is constructed by stitching the segments together. A segmentation loss can be used to adjust the segment boundaries to improve image quality. In some embodiments, image editing is performed iteratively, with the output of the differentiable pipeline serving as the new input image. Additionally, in some embodiments, any segments that have not been edited may use their corresponding segments from the input image, resulting in pixel perfect accuracy in the output image. Once all edits are complete, the resulting generated output image is returned to the user.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a process of segmented image generation in accordance with one or more embodiments;

FIG. 2 illustrates an example input image and segmentation mask in accordance with one or more embodiments;

FIG. 3 illustrates an example image generation system in accordance with one or more embodiments;

FIG. 4 illustrates an example image generation system in accordance with one or more embodiments;

FIG. 5 illustrates an example image generation system in accordance with one or more embodiments;

FIG. 6 illustrates an example image generation system in accordance with one or more embodiments;

FIG. 7 illustrates an example of image editing using an image generation system in accordance with one or more embodiments;

FIG. 8 illustrates an example of iterative image editing using an image generation system in accordance with one or more embodiments;

FIG. 9 illustrates a schematic diagram of an image generation system in accordance with one or more embodiments;

FIG. 10 illustrates a flowchart of a series of acts in a method of image generation in accordance with one or more embodiments;

FIG. 11 illustrates a schematic diagram of an exemplary environment in which the image processing system can operate in accordance with one or more embodiments; and

FIG. 12 illustrates a block diagram of an exemplary computing device in accordance with one or more embodiments.

### DETAILED DESCRIPTION

Many image editing algorithms these days are framed as latent space optimization of differentiable models, such as pre-trained generative adversarial networks (GANs). For example, the Smart Portrait feature of ADOBE® PHOTOSHOP® enables the face of a person to be edited by first retrieving a most similar face from the latent space of a StyleGAN network and then exploring its neighborhood in the latent space in order to make the desired edits.

Retrieving the exact face of a real person is, however, a hard problem. Embodiments address this problem through segmentation. For example, better results (e.g., a more realistic likeness of the input image) can be achieved on both retrieval and editing if the output image is divided into multiple segments. For example, an input image of a face may be divided into a mouth segment, and eyes segment, a nose segment, etc. A different latent code may then be optimized for each segment. As a result, when an image is reconstructed, each segment can be generated separately, and the final image composed from the generated segments and/or segments of the original input image. This reduces the number of constraints, which enables estimation of latent codes that produce a more accurate segment, as compared to a single latent code for an entire image. This also ensures precise localization, where changes in the latent code of one segment cannot affect other segments of the image since they are separately generated. This helps to retain fidelity of the original image. Additionally, this technique generalizes to more complicated editing tasks using different generators other than StyleGAN, or even a combination of multiple completely different generators.

One or more embodiments include a framework which combines segmentation and latent optimization in a single framework in order to accomplish a general image editing task defined as optimization. The generative capacity of modern neural networks is high, but not unlimited. In image editing using GANs, optimization typically includes a step called projection, which searches the latent space of the GAN for the face (or other object) closest in appearance to that shown in the input image.

Projection can often find a similar face (or other object), but not exact. This results in an output image that, while resembling the input, is still noticeably not the same as the input to a human observer. There have been a number of attempts to improve this projection process. For example, by tweaking the optimization process e.g., by initializing multiple times or transforming the space on which optimization happens. Alternatively, by replacing or supplementing the optimization with a pre-trained encoder that attempts to project into “better” regions of latent space (e.g., training a separate model to help improve the projection step). Another attempted improvement includes applying post-processing to repair the identity after the fact. However, this is time and resource intensive. Additionally, attempts have been made at finetuning the underlying generative model to improve projection. These are applied in state of art solutions, which however still produce problematic results.

As discussed, because the generative capacity of the network is ultimately limited, prior techniques which attempt to generate an entire new image often produce a result that is close but still perceptibly different in ways that, in the case of face editing in particular, change the identity of the subject. This results in the user receiving a final result which shows a different person's face. As a result, a significant amount of post-processing is required to make the result acceptable.

Using segmentation, embodiments improve performance significantly over prior techniques by breaking the problem up into easier to solve chunks. Specifically, a single subject of an input image (e.g., a face, or other object), can be segmented and generated using a plurality of generators. As such, the portion of the image corresponding to the subject, and not the entire image, is segmented and then generated. Additionally, these prior optimizations may still be used with various embodiments, to further improve the results. Further, by introducing segmentation into the optimization loop, embodiments allow existing image generation differentiable optimization pipelines to produce much better results in terms of final cost, by breaking the problem up in the image domain into smaller segments that can each be solved more easily.

In some embodiments, this is performed by introducing a segmentation layer into the optimization and thus using multiple copies of a generative model (or of different generative models) to solve the problem per region. Specifically in the face editing scenario this results in more accurate projection, with superior identity preservation and the ability to cleanly spatially disentangle partial edits. As discussed, by segmenting the object being generated, the search is less constrained. Accordingly, the most accurate projection for a specific segment of the image may result in an overall image that does not closely resemble the input image. For example, while the generated eyes segment may closely match the input image, the rest of the generated face may not resemble the input at all. This allows for the most accurate segment to be used rather than having to attempt to identify the projection that matches the entirety of the image.

In a traditional optimization pipeline of this kind, a generator creates an image, and then a loss function evaluates it. The partial gradients of the loss are then evaluated and backpropagated to the generator's latent vector, iterating until convergence. Unlike traditional optimization pipelines, embodiments insert a segmentation and compositing layer into the pipeline. This layer can combine images from multiple generators (which may or may not be copies of the same model) with different latent codes and combine them into a single image by assigning pixels from different generators to different segments of the subject. Loss is then evaluated and gradients backpropagated to each generator's latent code.

Segmentation can be fixed, or dynamically computed based on the actual pixel values of all the images to minimize stitching errors. In some embodiments, the segmentation is itself differentiable. This enables the ability to optimize the latent code for improved segmentation results. This also allows part of the image to be completely fixed to facilitate localized edits; in such case, pixels from the original image are preserved explicitly. Accordingly, those portions of the output image perfectly match the input image, with only specific segments of the output image being generated.

Embodiments result in improved image quality, as each generator can more accurately replicate a segment of the subject of an image than the entire image. Additionally, images can be generated more quickly, as the quality improvements do not require the post processing of prior solutions.

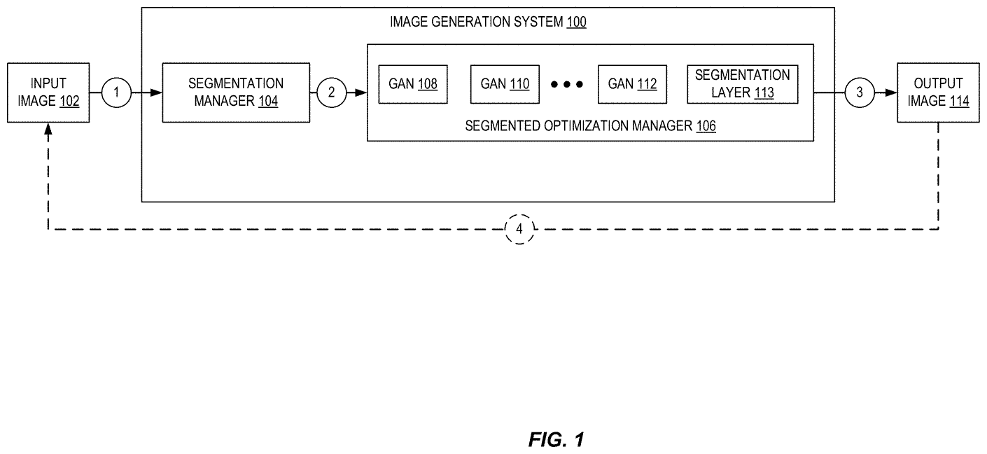

FIG. 1 illustrates a process of segmented image generation in accordance with one or more embodiments. Embodiments enable editing real images via generative adversarial networks (GAN). Unlike previous techniques, which treat all editing tasks as an operation that affects pixel values in the entire image, embodiments divide the image into a set of smaller segments. For each segment, corresponding latent codes of a generative network can be estimated with greater accuracy due to the lower number of constraints. When codes are altered by the user, the content in the image is manipulated locally while the rest of it remains unaffected. This ensures that changes made to one segment do not, and cannot, affect other regions of the image, as those regions are not being generated. Thanks to this property the final edited image better retains the original visual features of the input image and thus helps to preserve a more natural look. Additionally, the differentiable machine learning pipeline described with respect to the example of FIG. 1 and later-described embodiments is differentiable with respect to all inputs. As described further below, the backpropagation of partial gradients is used to optimize the pipeline.

Generative Adversarial Networks (GANs) are a type of machine learning technique which learn to generate new data that is similar to the data on which it was trained. For example, a GAN trained on images of cats will generate new images of cats, a GAN trained on images of faces will generate new images of faces, etc. With the increasing ability of GANs to generate images hardly distinguishable from real photographs, there have been numerous attempts to estimate latent code of the network generating images that look very close to the given input photo. By manipulating those codes in a specific direction, one may alter the appearance of the input photo in a specific way while retaining the original visual features, e.g., adding more hair to a bald person while retaining its identity.

FIG. 1 illustrates an example environment in which segmented image generation is performed in accordance with one or more embodiments. As illustrated in FIG. 1, the environment includes an image generation system 100. The image generation system may be implemented in a server device (e.g., as part of a cloud services environment, etc.) or on a client device (e.g., desktop or laptop computer, mobile device, etc.). In various embodiments, the image generation system 100 may be implemented as part of a digital design system. The digital design system generally facilitates the creation, modification, sharing, and/or deletion of graphical content including raster-based content. In one or more embodiments, the digital design system is a design application such as ADOBE® PHOTOSHOP®. In other embodiments, the digital design system includes multiple applications, functions, and operations relating to graphical content, such as an application suite, a web-based application, cloud-based application suite, etc.

As shown in FIG. 1, at numeral 1 an input image 102 is received by the image generation system. The term “image” or “digital image” refers to a digital graphics file that when rendered displays one or more objects. In particular, the term “image” comprises a digital file that, when rendered, includes visual representations of one or more objects, such as a person. For example, the term “digital image” includes, but is not limited to, digital files with the following file extensions: JPG, TIFF, BMP, PNG, RAW, or PDF. Thus, a digital image includes digital data or a digital file for an image that is displayable via a graphical user interface of a display of a computing device. In some embodiments, an image refers to a frame of a digital video. The term “digital video” refers to digital data representative of a sequence of visual images. In particular, a digital video includes a sequence of images which may include corresponding digital audio. For example, the term “digital video” includes, but is not limited to, digital files having one of the following file extensions: AVI, FLV, WMV, MOV, MP4. Similarly, as used herein, the term “frame” (or “frame of a digital video”) refers to a digital image from a digital video.

The input image may be segmented by segmentation manager 104. In some embodiments, segmentation manager 104 may include a pretrained semantic segmentation model. For example, a semantic segmentation model trained to segment faces may be used on input images of faces. Different semantic segmentation models may be used for segmenting input images of different objects. Additionally, or alternatively, segmentation manager 104 can provide a user interface through which the user can identify one or more segments in the input image (e.g., the user can “paint” all or portions of a segmentation mask on the input image).

The input image 102 and segmentation mask generated by segmentation manager 104, can then be provided to segmented optimization manager 106 at numeral 2. As shown in FIG. 1, the segmented optimization manager 106 may include a plurality of GANs 108-112 and a segmentation layer 113. In some embodiments, each GAN 108-113 may be a clone of a single trained model (e.g., same parameters, weights, etc.), but may each optimize their own latent space for a particular segment of input images. For example, where the input images are of faces, a first GAN may generate a segment corresponding to a right eye, a second GAN may generate a segment corresponding to a left eye, a third GAN may generate a segment corresponding to hair, and so on. As each GAN is tasked with producing a realistic generated image for only a particular segment of the input image, the result is much more realistic than a single GAN generated a realistic version of the entire input image. The resulting generated segments are then provided to the segmentation layer 113, which can stitch the segments together into output image 114.

The output image 114 is then output by the image generation system 100 at numeral 3. In some embodiments, the output image is returned to the user (e.g., displayed in a user interface of a digital design system, stored in a storage location accessible to the user, etc.). The user can then use the image as desired (e.g., incorporated into another document, etc.). Additionally, as discussed, in some embodiments, the input image 102 is a frame of an input video. In some embodiments, once one frame of the input video has been processed, then the next frame of the input video may be processed. This processing may continue until the entire input video has been processed. Alternatively, the user may specify a certain portion of the input video (e.g., by scene, by timestamps, etc.) to be processed by the image generation system 100. Once the specified portion of the input video has been processed (e.g., once each frame of the portion of the input video has been processed), then processing of the input video ends.

Optionally, in some embodiments, the images can be iteratively edited. For example, the output image 114 can then become the input image 102, and a further editing process can be performed, as shown at numeral 4. The output of a first edit becomes the input to a second edit. This enables users to make specific changes one at a time, which can provide a simpler and more intuitive editing process for the user.

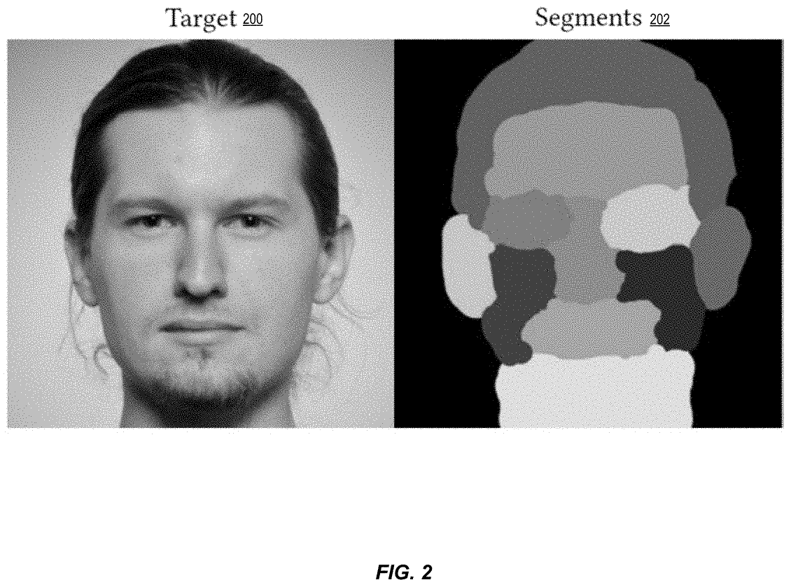

FIG. 2 illustrates an example input image and segmentation mask in accordance with one or more embodiments. As shown in FIG. 2, a target image 200 can be the input image to the image generation system. The segmentation manager can then divide the image into a plurality of segments 202. In the example of FIG. 2, the input image depicts a person's face, and the segments correspond to different portions of the input face. In various embodiments, the segmentation may be determined by a pretrained segmentation model, provided by the user, etc. As discussed, for example, the user can define the segments (e.g., by painting each segment over the input image or otherwise defining segment boundaries), or a segmentation model may be used which has been trained to identify segments of input images. Depending on the contents of the input image, a particular segmentation model may be used. For example, a face segmentation model may be used to generate segments 202 for input image 200. Likewise, were the input image to depict a different object or objects, then a corresponding segmentation model trained to segment the class of object or objects may be used. In some embodiments, the input image may be analyzed by a classifier to first identify the object(s) depicted in the input image and then route further processing to the segmentation model associated with the identified class. The segmentation may be fixed or may be updated dynamically based on a stitching loss, as discussed further below. For example, the segmentation may be optimized via backpropagation of partial gradients. This allows for the boundaries of the segmentation to change to produce a more accurate output image.

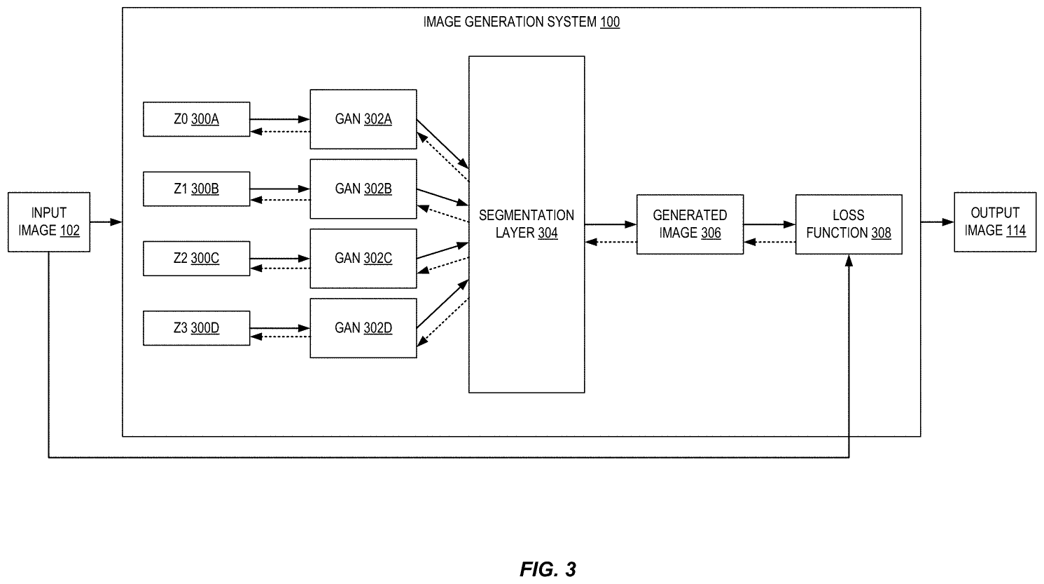

FIG. 3 illustrates an example image generation system in accordance with one or more embodiments. As shown in FIG. 3, image generation system 100 can receive an input image 102 and then use a plurality of GANs to generate an output image 114 that is close to the input image. When the input image is received, a latent code Z0-Z3 300A-300D is selected and provided to corresponding GANs 302A-302D. In the example of FIG. 3, each GAN 302A-302D may be a clone (e.g., share parameters, weights, etc.), but may each have their own latent space which can be optimized for the specific image segment which that GAN is responsible for reproducing. In some embodiments, the GAN used may be a StyleGAN, though other GANs may be used instead or additionally.

Each GAN 302A-302D generates an image which has been optimized to reproduce just the segment that GAN is responsible for. For example, each GAN performs a projection into its latent space of the segment it is responsible for, to identify a latent code that produces an image having a similar segment. As such, the generated image may not resemble the input image except for the one segment. For example, if the input image is of a face, and the GAN is responsible for generating a segment corresponding to the mouth, the generated image may have a similar mouth but no other similar features (e.g., the input face and the generated face, as a whole, may not resemble one another). The resulting images are then provided to segmentation layer 304, which stitches (e.g., composites) the appropriate segments from the images to create generated image 306. This is provided to a loss function 308 (such as an image loss function) which calculates a loss representing a difference between the input image and the generated image. A gradient descent is then passed back to each of the GANs, as shown via dotted lines, and used to optimize their latent spaces to select another latent code to generate another image that results in a lower loss. This may be repeated a set number of times, until the loss is below a threshold value, or based on other quality metric.

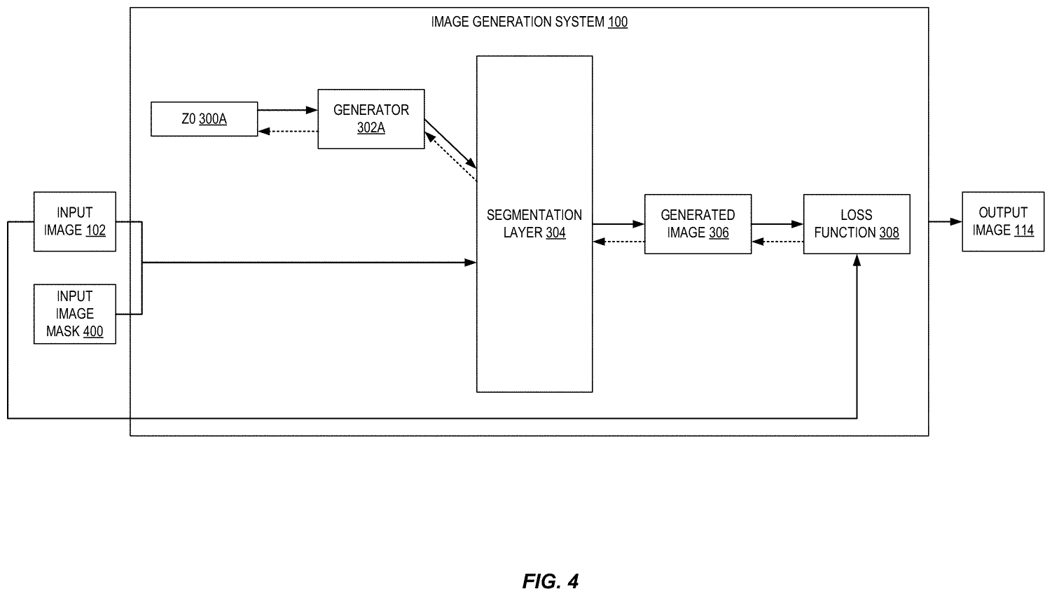

FIG. 4 illustrates an example image generation system in accordance with one or more embodiments. As shown in FIG. 4, in some embodiments, only a portion or portions of the input image may be intended to be edited. In such instances, only one or more generators may be used (e.g., the generator(s) associated with the segment of the image being edited). In the example of FIG. 4, a single generator 302A generates an image where a particular segment of the image is intended to be visually close to the corresponding segment of the input image 102. Accordingly, the segmentation layer 304 receives the image from generator 302A and the original input image 102 and an input image mask 400. The input image mask may be provided by the user (e.g., via segmentation manager 104, described above, or from other sources). The segmentation layer 304 then stitches together the segment of the image from generator 302A with the input image 102. This results in a perfectly disentangled edit being made to the image, as whatever is changed by generator 302A does not impact the rest of the image (as it is pixel-perfect from the input image).

For example, if the mouth of the face depicted in the input image is to be edited (e.g., to change the expression), then the input image and a mask indicating the mouth area of the image are provided. The generator 302A then optimizes for a mouth that resembles the segment of the input image that includes the mouth. The overall image generated by generator 302A may not closely resemble the input, and may look quite different, but the segments will resemble one another. Once the latent code has been found that produces an image with a similar segment, then the latent space can be explored to identify the desired changes to the segment. Once identified, the resulting image, input image, and mask, can be provided to the segmentation layer, which stitches the images together. This retains the pixel data of the original image except for the replaced segment which is taken from the image generated by generator 302A. As a result, the features within the segment are disentangled from the rest of the image, enabling changes to be made to the segment without affecting features of the rest of the generated image (as they are taken from the original image). As in the example of FIG. 4, once the resulting generated image 306 has a loss below a threshold (or other quality metric), the generated image is provided as output image 114.

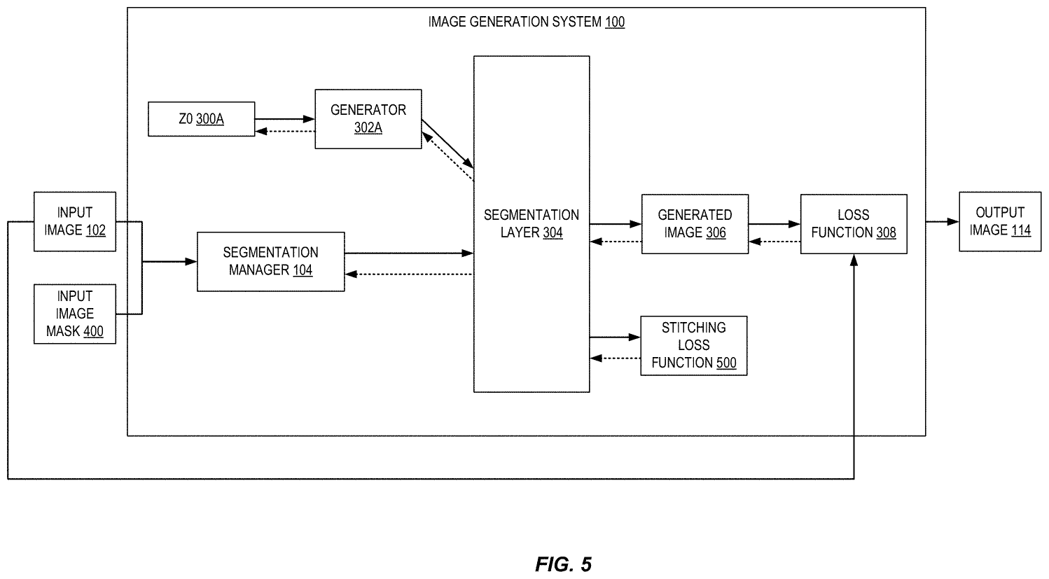

FIG. 5 illustrates an example image generation system in accordance with one or more embodiments. The example of FIG. 5 is similar to that of FIG. 4. However, in FIG. 5, an additional loss function, stitching loss 500, is added to the optimization loop. As in FIG. 4, an input image 102 and input image mask 400 are provided to image generation system 100. A generator 302A is then responsible for generating an image that is optimized such that the segment defined by the mask closely resembles the same area from the input image. Unlike in FIG. 4, where the segment is fixed, in the example of FIG. 5, the stitching loss 500 is calculated based on the stitching performed by the segmentation layer 304. For example, stitching loss may evaluate the difference at boundaries to determine the visibility of the stitching.

The resulting gradients are then backpropagated and used to update the boundaries of the input image mask. In some embodiments, the gradients are backpropagated to the segmentation manager 104 which can update the segmentation of the input image. This process iterates and optimizes both the boundaries of the mask, and the closeness of the segment of the generated image to the corresponding segment of the input image. Once optimized, the segment of the image generated by generator 302A and the input image 102 are stitched together by segmentation layer 304 and provided as output image 114.

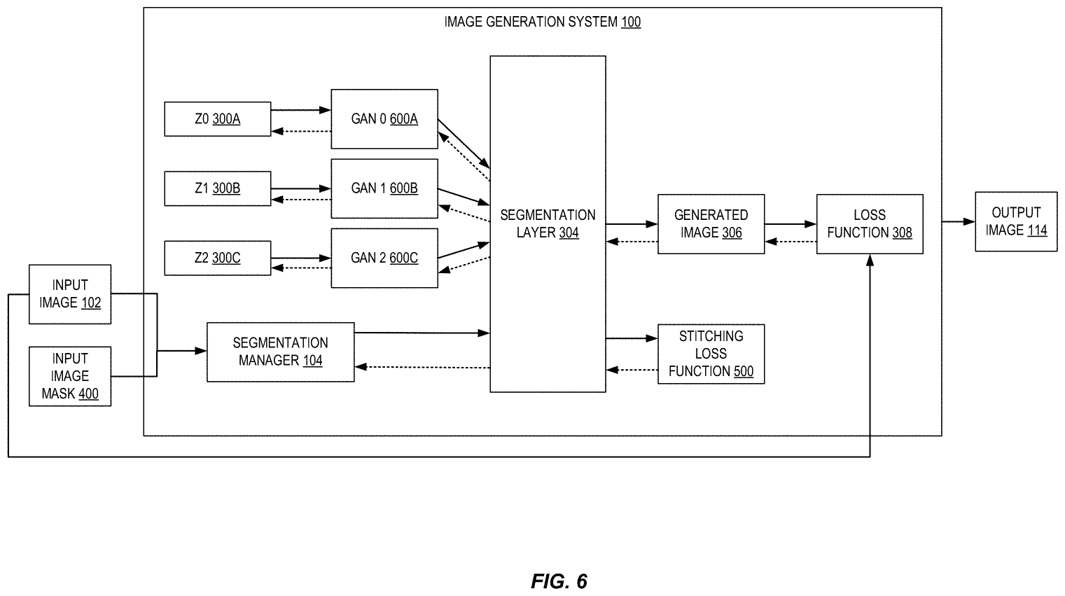

FIG. 6 illustrates an example image generation system in accordance with one or more embodiments. In the example of FIG. 6, a plurality of GANs 600A-600C are used to generate images optimized for different segments of input image 102. These GANs may be clones of the same model, different models, or different models, algorithms, etc., capable of outputting pixels (e.g., spatial transformers, etc.). For example, GAN 0 600A and GAN 1 600B may be clones of the same GAN model, while GAN 2 600C may be a different GAN model. Although three GANs are shown in the example of FIG. 6, in various embodiments there may be more or fewer GANs in such an implementation.

Additionally, an input image 102 and input image mask 400 are provided to image generation system 100. As discussed, in some embodiments, each GAN 600A-600C is responsible for generating an image that has been optimized such that a particular segment is visually close to the corresponding segment of the input image. By limiting any given GAN to matching a particular segment, rather than recreating the entire image, the quality of that segment can be greatly improved. Additionally, in the example of FIG. 6, if different models perform better when generating specific segments, then those models may be selected for those segments. Further, by incorporating stitching loss 500, the boundaries of the segments can be updated dynamically by changing the input image mask 400 based on the stitching loss via segmentation manager 104. Processing may generally be performed as in the examples described above.

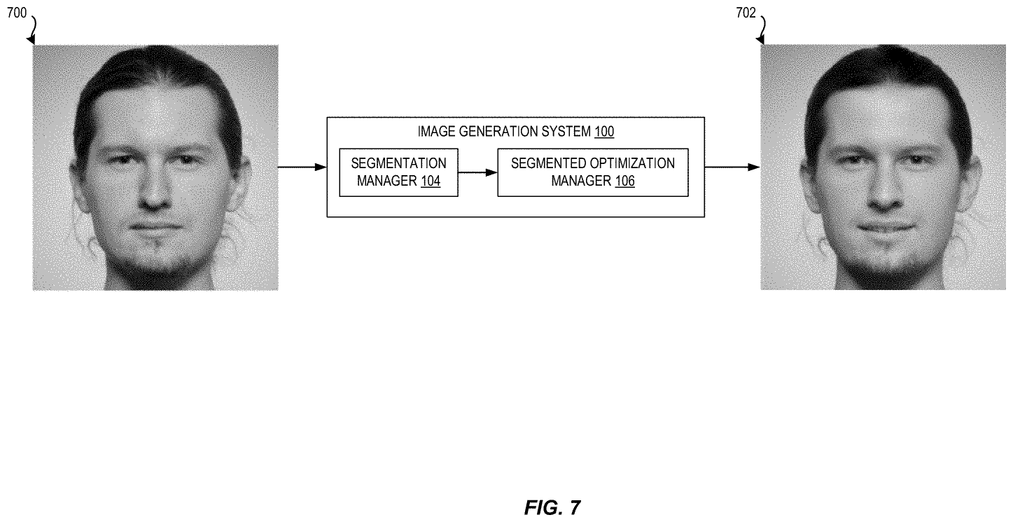

FIG. 7 illustrates an example of image editing using an image generation system in accordance with one or more embodiments. As shown in FIG. 7, a target (e.g., input) image 700 is received by image generation system 100 and an output image 702 with a changed facial expression is generated. As discussed, the input image 700 is segmented using segmentation manager 104 and segmented optimization manager 106 then generates one or more images where the selected segments are optimized to resemble the target image. The resulting segments are then stitched together to form the output generated image. In some embodiments, only the segments that include the intended change are generated while the rest of the image is taken from the input image. For example, in FIG. 7, a segment corresponding to the mouth may be generated to create a new expression while the rest of the image may be stitched from the input image. Alternatively, each segment is separately generated, and the results stitched together to generate an image that changes the expression of the input image without altering the identity of the subject of the input image.

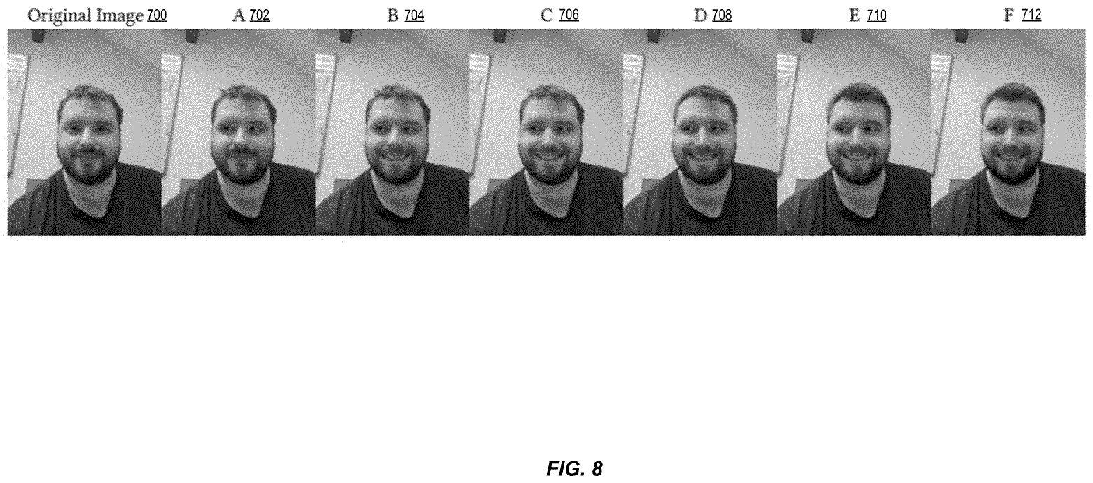

FIG. 8 illustrates an example of iterative image editing using an image generation system in accordance with one or more embodiments. As discussed, in some embodiments, an image may be edited iteratively. In such instances, the output of the first round of edits is then used as the input for the next round of edits. For example, original image 700 is provided to the image generation system and a gaze change edit is performed to generate image A 702. For example, as discussed, the original image may be segmented and then a projection is performed to match each segment. The image can then be edited by exploring the latent space of the projection to effect the intended edit. The results are then stitched to generate image A 702. Image A 702 can then be provided as input to the image generation system to make further edits, such as by changing the subject's expression as shown in image B 704. This editing may continue iteratively with the previous output image becoming the input image for the subsequent editing operation. For example, in image C 706, the subject's nose has been shrunk relative to image B 704; in images D 708 and E 710 the subject's haircut has been changed; and in image F 712 the subject's jawline has been changed.

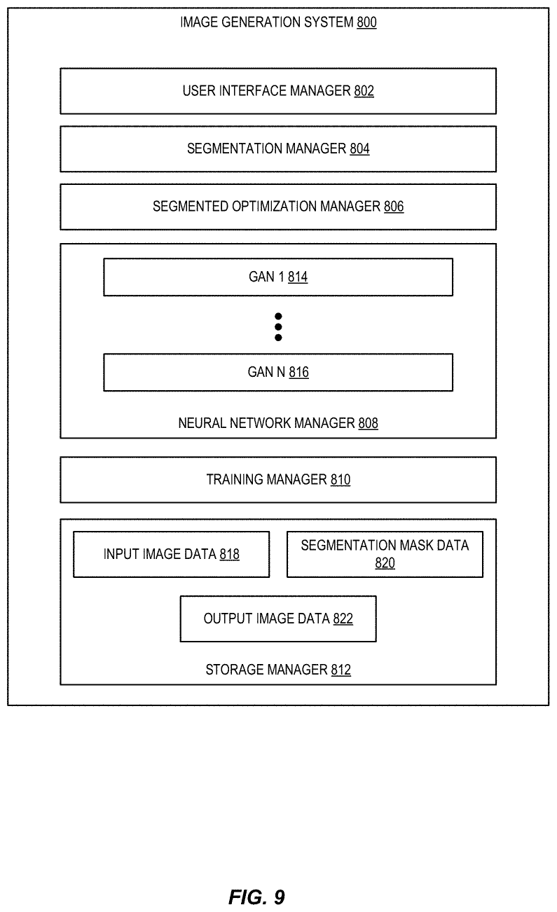

FIG. 9 illustrates a schematic diagram of image generation system (e.g., “image generation system” described above) in accordance with one or more embodiments. As shown, the image generation system 900 may include, but is not limited to, user interface manager 902, segmentation manager 904, segmented optimization manager 906, neural network manager 908, training manager 910, and storage manager 912. The neural network manager 908 includes a one or more generative adversarial networks 914-916. The storage manager 910 includes input image data 918, segmentation mask data 920, and output image data 922.

As illustrated in FIG. 9, the image generation system 900 includes a user interface manager 902. For example, the user interface manager 902 allows users to provide input image data to the image generation system 900. In some embodiments, the user interface manager 902 provides a user interface through which the user can upload the input images 918 which represent the target image to be generated, as discussed above. Alternatively, or additionally, the user interface may enable the user to download the images from a local or remote storage location (e.g., by providing an address (e.g., a URL or other endpoint) associated with an image source). In some embodiments, the user interface can enable a user to link an image capture device, such as a camera or other hardware to capture image data and provide it to the image generation system 900.

Additionally, the user interface manager 902 allows users to request the image generation system 900 to edit the generated image such as by changing features of the objects depicted in the input image. For example, where the input image includes a representation of a person's face, the user can request that the image generation system change the age, hair or eye color, expression, hairstyle, facial hair, etc. In some embodiments, the user interface manager 902 enables the user to view the resulting output image and/or request further edits to the image.

As illustrated in FIG. 9, the image generation system 900 also includes a segmentation manager 904. As discussed, in some embodiments, the segmentation manager 904 includes one or more pretrained semantic segmentation models. For example, a semantic segmentation model trained to segment faces may be used on input images of faces. Different semantic segmentation models may be used for segmenting input images of different objects. Additionally, or alternatively, segmentation manager 904 can provide a user interface (e.g., via user interface manager 902) through which the user can identify one or more segments in the input image (e.g., the user can “paint” all or portions of a segmentation mask on the input image).

As illustrated in FIG. 9, the image generation system 900 also includes a segmented optimization manager 906. As discussed, the segmented optimization manager 906 can manage processing of input images by a plurality of GANs 914-916. For example, given a real image I and segmentation masks S₁, . . . , n which correspond to regions in I, the segmented optimization manager 906 performs n separate projections of Sₙ(I) into the desired input latent space Xₙ. The domain of X is not necessarily fixed, in general it can be any input space which can compactly represent inputs into the GAN. In the case of StyleGAN v2, this can be z, [symbol] , [symbol] +, S-space, and so on. The particular method of performing individual projections can include various methods as are known in the art and does not need to be the same for every projection, e.g., if one method works better for projecting large segments but does not work that well for small segments, then both methods may be used for the segments they work best one.

The function of S(I) depends on the method which provides the input based on I. In the case of gradient descent on some image loss [symbol] , S(I) can be a compositing function which combines the region of interest defined by Sₖ with I, such that per-pixel loss outside of the region is 0. Some embodiments use a feed-forward code estimation, which may be implemented by providing a mask as part of the input and altering the training regime of the code-providing network.

Compositing the projected segments back into the final image poses some challenges, as in general, the methods of projecting do not guarantee there will be continuity on segment boundaries. One way to improve continuity is by ensuring the segments are partially overlapping—or equivalently, the projection loss function is conditioned to additionally consider a small neighborhood around the segment. If there are areas of the input image that do not need to be edited, then these areas can be excluded from the projection altogether and substituted with their corresponding portions of I.

Additionally, to achieve even better inversion, embodiments can fine tune the underlaying model for each segment, using techniques like Pivotal Tuning. Much like in the projection task, fine tuning is made considerably easier with reduced constraints offered by only considering the region of interest (e.g., the particular segment associated with that network).

Once the projection has been obtained, latent space edits are performed to achieve natural-looking changes in the input image, such as changing a person's gaze or haircut. Composites which reach best editability are achieved when S is close to semantic segmentation, such as including individual facial features, similar to the mask described above with respect to FIG. 2.

The edits performed can include locally global edits, where all of the segments are changed in the same direction, in hopes of achieving a consistent change. For example, embodiments can perform various [symbol] _{edited}^{k}= [symbol] ^{k}+αD, with known directions D, and then compose the final image using S.

Another possible image modification is layered, where segments are optimized sequentially, edited, and the final image becomes new I for the next iteration of changes. This type is shown in FIG. 8. This has an advantage in being very easy for users of this process to specify what exactly they want to change, view the result, and go back and revise as needed by making additional changes to the same or different segments.

When compositing an edited image, even when the edits are consistent on all segments at the same time, continuity between segments will almost surely be affected to some degree, and thus correction is necessary. Accordingly, in some embodiments image editing techniques, such as Poisson image editing, can be used between the segments to hide minor discrepancies, such that the final image still looks natural.

Additionally, as discussed, the segmentation S does not need to hold constant throughout the search for X. The n projections can be batch-processed, and if using an iterative optimization method, the state of the total projection at each step can be observed. This offers an opportunity to check whether any changes should be applied to S (e.g., change the boundaries of the segments) in an attempt to obtain a better overall result.

In some embodiments, multiple goals of refinement can be defined. For example, one goal is avoiding segment lines going through low-frequency features. There are many ways to achieve this automatic refinement of segmentation. For example, level sets in the difference of gradient images of adjacent segments can be found and the segments adjusted to minimize this metric along a new hard segment boundary. Similarly, S should change during the editing, and it becomes especially helpful when performing edits that change features near a segment boundary, as the neighboring segments are no longer likely to be consistent.

As illustrated in FIG. 9, the image generation system 900 also includes a neural network manager 904. Neural network manager 908 may host a plurality of neural networks or other machine learning models, such as generative adversarial networks (GANs) 914-916. The neural network manager 908 may include an execution environment, libraries, and/or any other data needed to execute the machine learning models. In some embodiments, the neural network manager 908 may be associated with dedicated software and/or hardware resources to execute the machine learning models. As discussed, GANs 914-916 can be implemented as any type of generator network, such as StyleGAN or other generators. In various embodiments, each GAN hosted by neural network manager 908 may be the same type of generator or may be different types of generators, depending on implementation. Although depicted in FIG. 9 as being hosted by a single neural network manager 908, in various embodiments the neural networks may be hosted in multiple neural network managers and/or as part of different components. For example, each GAN 914-916 can be hosted by their own neural network manager, or other host environment, in which the respective neural networks execute, or the GANs may be spread across multiple neural network managers depending on, e.g., the resource requirements of each GAN, etc.

As illustrated in FIG. 9 the image generation system 900 also includes training manager 910. The training manager 910 can teach, guide, tune, and/or train one or more neural networks. In particular, the training manager 910 can train a neural network based on a plurality of training data. For example, the GANs 914-916 may be trained to generate images of specific types of objects or portions of specific types of objects. Additionally, the GANs may be further optimized using loss functions, as discussed above, by backpropagating gradient descents. More specifically, the training manager 910 can access, identify, generate, create, and/or determine training input and utilize the training input to train and fine-tune a neural network. For instance, the training manager 910 can train the GANs 914-916, end-to-end, as discussed above.

As illustrated in FIG. 9, the image generation system 900 also includes the storage manager 910. The storage manager 910 maintains data for the image generation system 900. The storage manager 910 can maintain data of any type, size, or kind as necessary to perform the functions of the image generation system 900. The storage manager 910, as shown in FIG. 9, includes the input image data 918. The input image data 918 can include a one or more digital images, as discussed in additional detail above. In some embodiments, the input image data 918 can include digital video data. For example, the input image data 918 may include frames of a digital video.

As further illustrated in FIG. 9, the storage manager 910 also includes segmentation mask data 920. The segmentation mask data can be generated by the user (e.g., by painting or otherwise defining segments of a corresponding input image) or may be generated by another entity and provided with the corresponding input image. The storage manager 910 may also include output image data 922. The output image data 922 can include an output image that has been generated and stitched together, as discussed. In some embodiments, the input image data and output image data comprise frames of a digital video.

Each of the components 902-912 of the image generation system 900 and their corresponding elements (as shown in FIG. 9) may be in communication with one another using any suitable communication technologies. It will be recognized that although components 902-912 and their corresponding elements are shown to be separate in FIG. 9, any of components 902-912 and their corresponding elements may be combined into fewer components, such as into a single facility or module, divided into more components, or configured into different components as may serve a particular embodiment.

The components 902-912 and their corresponding elements can comprise software, hardware, or both. For example, the components 902-912 and their corresponding elements can comprise one or more instructions stored on a computer-readable storage medium and executable by processors of one or more computing devices. When executed by the one or more processors, the computer-executable instructions of the image generation system 900 can cause a client device and/or a server device to perform the methods described herein. Alternatively, the components 902-912 and their corresponding elements can comprise hardware, such as a special purpose processing device to perform a certain function or group of functions. Additionally, the components 902-912 and their corresponding elements can comprise a combination of computer-executable instructions and hardware.

Furthermore, the components 902-912 of the image generation system 900 may, for example, be implemented as one or more stand-alone applications, as one or more modules of an application, as one or more plug-ins, as one or more library functions or functions that may be called by other applications, and/or as a cloud-computing model. Thus, the components 902-912 of the image generation system 900 may be implemented as a stand-alone application, such as a desktop or mobile application. Furthermore, the components 902-912 of the image generation system 900 may be implemented as one or more web-based applications hosted on a remote server. Alternatively, or additionally, the components of the image generation system 900 may be implemented in a suit of mobile device applications or “apps.” To illustrate, the components of the image generation system 900 may be implemented as part of an application, or suite of applications, including but not limited to ADOBE CREATIVE CLOUD, ADOBE PHOTO SHOP, ADOBE ACROBAT, ADOBE ILLUSTRATOR, ADOBE LIGHTROOM and ADOBE INDESIGN. “ADOBE”, “CREATIVE CLOUD,” “PHOTO SHOP,” “ACROBAT,” “ILLUSTRATOR,” “LIGHTROOM,” and “INDESIGN” are either registered trademarks or trademarks of Adobe Inc. in the United States and/or other countries.

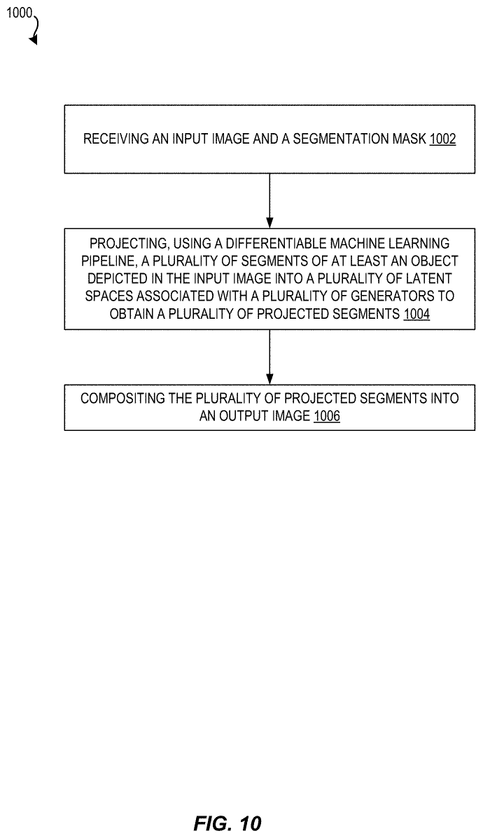

FIGS. 1-9, the corresponding text, and the examples, provide a number of different systems and devices that allows a user to perform segmented image generation. In addition to the foregoing, embodiments can also be described in terms of flowcharts comprising acts and steps in a method for accomplishing a particular result. For example, FIG. 10 illustrates a flowchart of an exemplary method in accordance with one or more embodiments. The method described in relation to FIG. 10 may be performed with fewer or more steps/acts or the steps/acts may be performed in differing orders. Additionally, the steps/acts described herein may be repeated or performed in parallel with one another or in parallel with different instances of the same or similar steps/acts.

FIG. 10 illustrates a flowchart 1000 of a series of acts in a method of image generation in accordance with one or more embodiments. In one or more embodiments, the method 1000 is performed in a digital medium environment that includes an image generation system. The method 1000 is intended to be illustrative of one or more methods in accordance with the present disclosure and is not intended to limit potential embodiments. Alternative embodiments can include additional, fewer, or different steps than those articulated in FIG. 10.

As illustrated in FIG. 10, the method 1000 includes an act 1002 of receiving an input image and a segmentation mask. As discussed, in some embodiments, the input image has a corresponding segmentation mask. Alternatively, the user generates a segmentation mask (e.g., by painting or otherwise defining the boundaries of the segments) via a user interface. Additionally, or alternatively, a segmentation model is used to generate an initial segmentation mask which may, optionally, be further refined by the user or other entity.

As illustrated in FIG. 10, the method 1000 also includes an act 1004 of projecting, using a differentiable machine learning pipeline, a plurality of segments of at least an object depicted in the input image into a plurality of latent spaces associated with a plurality of generators to obtain a plurality of projected segments. For example, the subject of an input image (e.g., a person's face or other object) is segmented into a plurality of segments and each segment is generated separately. As discussed, this provides improved visual fidelity for the generated segments because the generator has fewer constraints. For example, while the specific segment generated may closely resemble the input image's segment, the rest of the generated image may not resemble the input image at all. However, because only the specific segment of the generated image is being used, the rest of the generated image does not need to match the input image. In some embodiments, the differentiable machine learning pipeline includes a segmentation layer and a segmentation mask manager. Gradients obtained using one or more loss functions may be backpropagated to each generator and the segmentation layer.

As illustrated in FIG. 10, the method 1000 also includes an act 1006 of projecting compositing the plurality of projected segments into an output image. As discussed, once the segments have been generated, they may be stitched together to form the final output image. In some embodiments, a stitching loss may be used to adjust the segment boundaries to improve output image quality. Other image processing techniques, such as blending, or Poisson image editing may be used during stitching to improve output quality.

In some embodiments, the method further includes receiving a request to edit a first portion of the input image, determining a segment of the input image corresponding to the first portion of the input image, generating, by a generator corresponding to the segment of the input image, an edited image by exploring the latent space associated with the generator, and generating an edited output image by compositing the edited image with the input image.

In some embodiments, the plurality of generators are clones of a generator model. In some embodiments, the plurality of generators includes two or more different generator models. In some embodiments, the segmentation mask is dynamically updated based on a stitching loss calculated by a stitching layer.

In some embodiments, receiving an input image and a segmentation mask further includes processing the input image using a semantic segmentation model to generate the segmentation mask. In some embodiments, receiving an input image and a segmentation mask further includes receiving an input identifying at least one segment of the segmentation mask via a user interface, wherein the input includes painting the at least one segment on a representation of the input image.

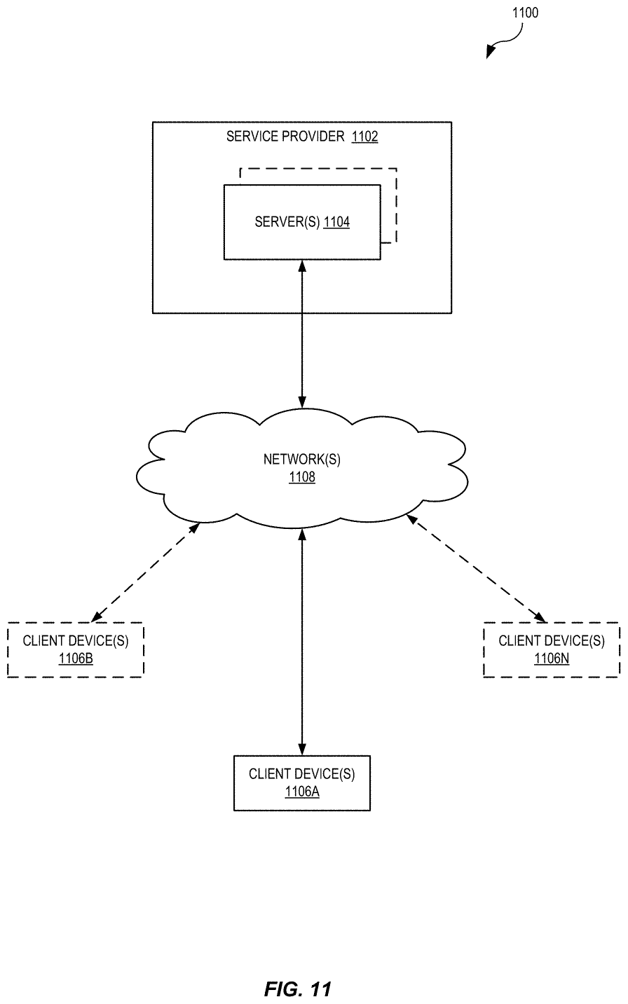

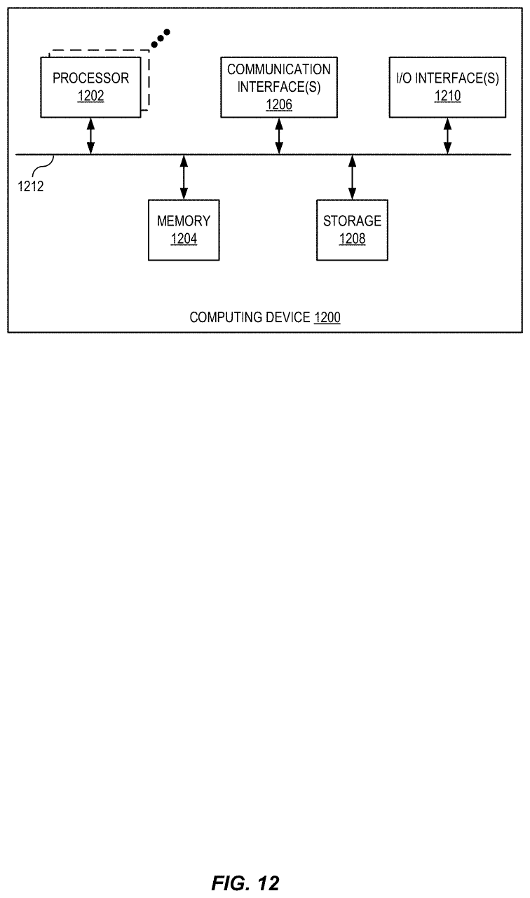

FIG. 11 illustrates a schematic diagram of an exemplary environment 1100 in which the image generation system can operate in accordance with one or more embodiments. In one or more embodiments, the environment 1100 includes a service provider 1102 which may include one or more servers 1104 connected to a plurality of client devices 1106A-1106N via one or more networks 1108. The client devices 1106A-1106N, the one or more networks 1108, the service provider 1102, and the one or more servers 1104 may communicate with each other or other components using any communication platforms and technologies suitable for transporting data and/or communication signals, including any known communication technologies, devices, media, and protocols supportive of remote data communications, examples of which will be described in more detail below with respect to FIG. 12.

Although FIG. 11 illustrates a particular arrangement of the client devices 1106A-1106N, the one or more networks 1108, the service provider 1102, and the one or more servers 1104, various additional arrangements are possible. For example, the client devices 1106A-1106N may directly communicate with the one or more servers 1104, bypassing the network 1108. Or alternatively, the client devices 1106A-1106N may directly communicate with each other. The service provider 1102 may be a public cloud service provider which owns and operates their own infrastructure in one or more data centers and provides this infrastructure to customers and end users on demand to host applications on the one or more servers 1104. The servers may include one or more hardware servers (e.g., hosts), each with its own computing resources (e.g., processors, memory, disk space, networking bandwidth, etc.) which may be securely divided between multiple customers, each of which may host their own applications on the one or more servers 1104. In some embodiments, the service provider may be a private cloud provider which maintains cloud infrastructure for a single organization. The one or more servers 1104 may similarly include one or more hardware servers, each with its own computing resources, which are divided among applications hosted by the one or more servers for use by members of the organization or their customers.

Similarly, although the environment 1100 of FIG. 11 is depicted as having various components, the environment 1100 may have additional or alternative components. For example, the environment 1100 can be implemented on a single computing device with the image generation system. In particular, the image generation system may be implemented in whole or in part on the client device 1102A.

As illustrated in FIG. 11, the environment 1100 may include client devices 1106A-1106N. The client devices 1106A-1106N may comprise any computing device. For example, client devices 1106A-1106N may comprise one or more personal computers, laptop computers, mobile devices, mobile phones, tablets, special purpose computers, TVs, or other computing devices, including computing devices described below with regard to FIG. 12. Although three client devices are shown in FIG. 11, it will be appreciated that client devices 1106A-1106N may comprise any number of client devices (greater or smaller than shown).

Moreover, as illustrated in FIG. 11, the client devices 1106A-1106N and the one or more servers 1104 may communicate via one or more networks 1108. The one or more networks 1108 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1108 may be any suitable network over which the client devices 1106A-1106N may access service provider 1102 and server 1104, or vice versa. The one or more networks 1108 will be discussed in more detail below with regard to FIG. 12.

In addition, the environment 1100 may also include one or more servers 1104. The one or more servers 1104 may generate, store, receive, and transmit any type of data. For example, a server 1104 may receive data from a client device, such as the client device 1106A, and send the data to another client device, such as the client device 1102B and/or 1102N. The server 1104 can also transmit electronic messages between one or more users of the environment 1100. In one example embodiment, the server 1104 is a data server. The server 1104 can also comprise a communication server or a web-hosting server. Additional details regarding the server 1104 will be discussed below with respect to FIG. 12.

As mentioned, in one or more embodiments, the one or more servers 1104 can include or implement at least a portion of the image generation system. In particular, the image generation system can comprise an application running on the one or more servers 1104 or a portion of the image generation system can be downloaded from the one or more servers 1104. For example, the image generation system can include a web hosting application that allows the client devices 1106A-1106N to interact with content hosted at the one or more servers 1104. To illustrate, in one or more embodiments of the environment 1100, one or more client devices 1106A-1106N can access a webpage supported by the one or more servers 1104. In particular, the client device 1106A can run a web application (e.g., a web browser) to allow a user to access, view, and/or interact with a webpage or website hosted at the one or more servers 1104.

Upon the client device 1106A accessing a webpage or other web application hosted at the one or more servers 1104, in one or more embodiments, the one or more servers 1104 can provide access to one or more digital images (e.g., the input image data, such as camera roll or an individual's personal photos) stored at the one or more servers 1104. Moreover, the client device 1106A can receive a request (i.e., via user input) to generate and/or edit an image similar to the input image and provide the request to the one or more servers 1104. Upon receiving the request, the one or more servers 1104 can automatically perform the methods and processes described above to generate the requested image. The one or more servers 1104 can provide the resulting image to the client device 1106A for display to the user.

As just described, the image generation system may be implemented in whole, or in part, by the individual elements 1102-1108 of the environment 1100. It will be appreciated that although certain components of the image generation system are described in the previous examples with regard to particular elements of the environment 1100, various alternative implementations are possible. For instance, in one or more embodiments, the image generation system is implemented on any of the client devices 1106A-N. Similarly, in one or more embodiments, the image generation system may be implemented on the one or more servers 1104. Moreover, different components and functions of the image generation system may be implemented separately among client devices 1106A-1106N, the one or more servers 1104, and the network 1108.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that one or more computing devices such as the computing device 1200 may implement the image processing system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A computer-implemented method comprising:
receiving an input image and a segmentation mask;
projecting, using a differentiable machine learning pipeline, a plurality of segments of at least an object depicted in the input image into a plurality of latent spaces associated with a plurality of generators to obtain a plurality of projected segments; and
compositing the plurality of projected segments into an output image.

2. The computer-implemented method of claim 1, further comprising:
receiving a request to edit a first portion of the input image;
determining a segment of the input image corresponding to the first portion of the input image;
generating, by a generator corresponding to the segment of the input image, an edited image by exploring the latent space associated with the generator; and
generating an edited output image by compositing the edited image with the input image.

3. The computer-implemented method of claim 1, wherein the plurality of generators are clones of a generator model.

4. The computer-implemented method of claim 1, wherein the plurality of generators includes two or more different generator models.

5. The computer-implemented method of claim 1, wherein the segmentation mask is dynamically updated based on a stitching loss calculated by a stitching layer.

6. The computer-implemented method of claim 1, wherein receiving an input image and a segmentation mask further comprises:
processing the input image using a semantic segmentation model to generate the segmentation mask.

7. The computer-implemented method of claim 1, wherein receiving an input image and a segmentation mask further comprises:
receiving an input identifying at least one segment of the segmentation mask via a user interface, wherein the input includes painting the at least one segment on a representation of the input image.

8. A non-transitory computer readable storage medium including instructions stored thereon which, when executed by a processor, cause the processor to:
receive an input image and a segmentation mask;
project, using a differentiable machine learning pipeline, a plurality of segments of the input image into a plurality of latent spaces associated with a plurality of generators to obtain a plurality of projected segments; and
composite the plurality of projected segments into an output image.

9. The non-transitory computer readable storage medium of claim 8, wherein the instructions, when executed, further cause the processor to:
receive a request to edit a first portion of the input image;
determine a segment of the input image corresponding to the first portion of the input image;
generate, by a generator corresponding to the segment of the input image, an edited image by exploring the latent space associated with the generator; and
generate an edited output image by compositing the edited image with the input image.

10. The non-transitory computer readable storage medium of claim 8, wherein the plurality of generators are clones of a generator model.

11. The non-transitory computer readable storage medium of claim 8, wherein the plurality of generators includes two or more different generator models.

12. The non-transitory computer readable storage medium of claim 8, wherein the segmentation mask is dynamically updated based on a stitching loss calculated by a stitching layer.

13. The non-transitory computer readable storage medium of claim 8, wherein to receive an input image and a segmentation mask, the instructions, when executed, further cause the processor to:
process the input image using a semantic segmentation model to generate the segmentation mask.

14. The non-transitory computer readable storage medium of claim 8, wherein to receive an input image and a segmentation mask, the instructions, when executed, further cause the processor to:
receive an input identifying at least one segment of the segmentation mask via a user interface, wherein the input includes painting the at least one segment on a representation of the input image.

15. A system comprising:
at least one processor; and
a memory including instructions stored thereon which, when executed by the at least one processor, cause the system to:
receive an input image and a segmentation mask;
project, using a differentiable machine learning pipeline, a plurality of segments of the input image into a plurality of latent spaces associated with a plurality of generators to obtain a plurality of projected segments; and
composite the plurality of projected segments into an output image.

16. The system of claim 15, wherein the instructions, when executed, further cause the system to:
receive a request to edit a first portion of the input image;
determine a segment of the input image corresponding to the first portion of the input image;
generate, by a generator corresponding to the segment of the input image, an edited image by exploring the latent space associated with the generator; and
generate an edited output image by compositing the edited image with the input image.

17. The system of claim 15, wherein the plurality of generators are clones of a generator model.

18. The system of claim 15, wherein the plurality of generators includes two or more different generator models.

19. The system of claim 15, wherein the segmentation mask is dynamically updated based on a stitching loss calculated by a stitching layer.

20. The system of claim 15, wherein to receive an input image and a segmentation mask, the instructions, when executed, further cause the system to:
process the input image using a semantic segmentation model to generate the segmentation mask.
